(19) United States
(12) Patent Application Publication
(10) Pub. No.: US 2012/0069147 A1
(43) Pub. Date: Mar. 22, 2012

(54) DISPLAY DEVICE AND DISPLAY METHOD

(75) Inventor: Akinari Todoroki, Okaya-shi (JP)

(73) Assignee: Seiko Epson Corporation, Tokyo (JP)

(21) Appl. No.: 13/238,257

(22) Filed: Sep. 21, 2011

(30) Foreign Application Priority Data
Sep. 21, 2010 (JP) 2010-210515

(51) Int. Cl. H04N 13/00

(52) U.S. Cl. 348/43; 348/E13.026

(57) ABSTRACT

A display device includes: a determiner that determines a video format of a stereoscopic video picture which is input as an input video picture and includes a right-eye image and a left-eye image; a video processor that generates a right-eye frame and a left-eye frame from the input video picture based on the video format determined by the determiner and outputs a stereoscopic video picture including the right-eye frame and the left-eye frame; a display unit that displays images with a predetermined display resolution; and a display controller that converts the resolution of the respective frames included in the stereoscopic video picture output by the video processor into the display resolution and causes the display unit to display the images.

The entire disclosure of Japanese Patent Application No. 2010-210515, filed Sep. 21, 2010 is expressly incorporated by reference herein.

### BACKGROUND

1. Technical Field

The present invention relates to a display device and a display method.

2. Related Art

A time-division display method is known as a method of displaying stereoscopic video pictures. In the time-division display method, a display device alternately displays left and right-eye images with parallax. When a person wearing a glasses-type filter which includes a shutter that is synchronized with switching of the left and right-eye images or a circularly polarized lens views the images through the filter, the images are recognized as stereoscopic video pictures.

In the time-division display method, so-called crosstalk may occur wherein the left and right-eye images are mixed and recognized at the switching timing of the left and right-eye images. As a method for solving crosstalk, in the related art, a method of driving a display device at a high frame rate of 240 Hz, for example is proposed (for example, see JP-T-2009-509398).

However, when the frame rate is increased, the amount of data expanded in a frame memory increases excessively with the resolution of an image. Thus, a large amount of resources are needed in order to display the video smoothly. That is, a high-performance arithmetic processor and a large-capacity memory are needed in order to increase the display resolution of the image.

### SUMMARY

An advantage of some aspects of the invention is that it provides a display device and method capable of displaying an image smoothly at a high frame rate corresponding with an increase in resolution of the image.

One aspect of the invention is directed to a display device including: a determiner that determines a video format of a stereoscopic video picture which is input as an input video picture and includes a right-eye image and a left-eye image; a video processor that generates a right-eye frame and a left-eye frame from the input video picture based on the video format determined by the determiner and outputs a stereoscopic video picture including the right-eye frame and the left-eye frame; a display unit that displays images with a predetermined display resolution; and a display controller that converts the resolution of the respective frames included in the stereoscopic video picture output by the video processor into the display resolution and causes the display unit to display the images.

According to the aspect of the invention, the resolution is not converted in the process of generating the right-eye frame and the left-eye frame from the stereoscopic video picture including the right-eye image and the left-eye image, but the resolution is converted so as to match the display resolution of the display unit when displaying the images on the display unit. According to this configuration, since the display device does not have a step which involves storing resolution-converted video pictures in the frame memory and processing the video pictures, it is possible to save the resources for processing the video pictures of which the amount of information is increased due to resolution conversion. Thus, it is possible to decrease the processing load when displaying an input video picture having a resolution different from a display resolution and to display a high-resolution image smoothly at a high frame rate.

According to one aspect of the invention, since the video processor does not perform resolution conversion when generating the right-eye frame and the left-eye frame, a memory for expanding video pictures having a high resolution through resolution conversion is not needed. Thus, it is possible to decrease the load associated with a series of processes of converting the resolution of video pictures and displaying the resolution-converted video pictures.

According to one aspect of the invention, since the display controller performs the process of converting the resolution in units of horizontal lines and sequentially displays the images of each of the processed lines to the display unit, a step of expanding the video pictures of which the resolution is converted into a frame memory is not needed. Thus, it is possible to display high-resolution video pictures smoothly at a high frame rate.

According to one aspect of the invention, it is possible to generate the right-eye frame and the left-eye frame at high speed from the stereoscopic video picture having the side-by-side format which is the first video format and to convert the resolution of the generated frames at high speed by performing horizontal interpolation. Moreover, it is possible to sequentially display the converted video pictures in units of horizontal lines. In this way, it is possible to convert the frame rate and the resolution of the stereoscopic video pictures at high speed and to display the stereoscopic video pictures smoothly with few resources.

According to one aspect of the invention, it is possible to generate the right-eye frame and the left-eye frame at high speed from the stereoscopic video picture having the top-and-bottom format which is the second video format and to convert the resolution of the frames by performing vertical interpolation. Moreover, it is possible to sequentially display the converted video pictures. In this way, it is possible to convert the frame rate and the resolution of the stereoscopic video pictures at high speed and to display the stereoscopic video pictures smoothly with few resources.

According to one aspect of the invention, it is possible to generate the right-eye frame and the left-eye frame at high speed from the stereoscopic video picture having the line-by-line format which is the third video format and to convert the resolution of the frames by performing vertical interpolation. Moreover, it is possible to sequentially display the converted video pictures. In this way, it is possible to convert the frame rate and the resolution of the stereoscopic video pictures at high speed and to display the stereoscopic video pictures smoothly with few resources.

According to one aspect of the invention, after the size, namely the vertical or horizontal resolution, of the stereoscopic video picture having the frame packing format which is the fourth video format is compressed, the right-eye frame and the left-eye frame are generated. When displaying the respective frames, the frames are displayed while converting the resolution by performing interpolation so as to compensate for the compression. Thus, it is possible to process high-resolution stereoscopic video pictures with few resources and to display the stereoscopic video pictures smoothly.

According to one aspect of the invention, the resolution is converted into a high resolution by interpolating the stereoscopic video pictures compressed in the horizontal or vertical direction depending on the compression state so that video pictures before compression can be reproduced. Thus, it is possible to display high-quality stereoscopic video pictures.

According to the aspect of the invention, the resolution is not converted in the process of generating the right-eye frame and the left-eye frame from the stereoscopic video picture including the right-eye image and the left-eye image, but the resolution is converted so as to match the display resolution of the display unit when displaying the images on the display unit. According to this configuration, since the display device does not have a step which involves storing resolution-converted video pictures in the frame memory and processing the video pictures, it is possible to save the resources for processing the video pictures of which the amount of information is increased due to resolution conversion. Thus, it is possible to decrease the processing load when displaying an input video picture having a resolution different from a display resolution and to display a high-resolution image smoothly at a high frame rate.

According to the aspect of the invention, it is possible to decrease the processing load when displaying an input video picture having a resolution different from a display resolution and to display a high-resolution image smoothly at a high frame rate.

### BRIEF DESCRIPTION OF THE DRAWINGS

The invention will be described with reference to the accompanying drawings, wherein like numbers reference like elements.

FIG. 1 is a block diagram showing a functional configuration of a display device according to an embodiment of the invention.

FIG. 2 is a diagram schematically showing the operation of a video processing device when processing side-by-side input data.

FIGS. 3A and 3B are diagrams schematically showing a process of interpolating pixel data of respective frames of a stereoscopic video picture, in which FIG. 3A shows a process of performing horizontal interpolation on the pixel data, and FIG. 3B shows a process of performing horizontal zigzag interpolation on the pixel data.

FIGS. 4A and 4B are diagrams showing the relationship between the timings of the writing of a liquid crystal light valve and the opening/closing of a filter, in which FIG. 4A shows the timings when driving at 120 Hz, and FIG. 4B shows the timings when driving at 240 Hz.

FIG. 5 is a diagram schematically showing the operation of a video processing device when processing top-and-bottom input data.

FIG. 6 is a diagram schematically showing a process of performing vertical interpolation on pixel data of respective frames of a stereoscopic video picture.

FIG. 7 is a diagram schematically showing the operation of a video processing device when processing frame packing input data.

### DESCRIPTION OF EXEMPLARY EMBODIMENTS

Hereinafter, an embodiment of the invention will be described with reference to the drawings.

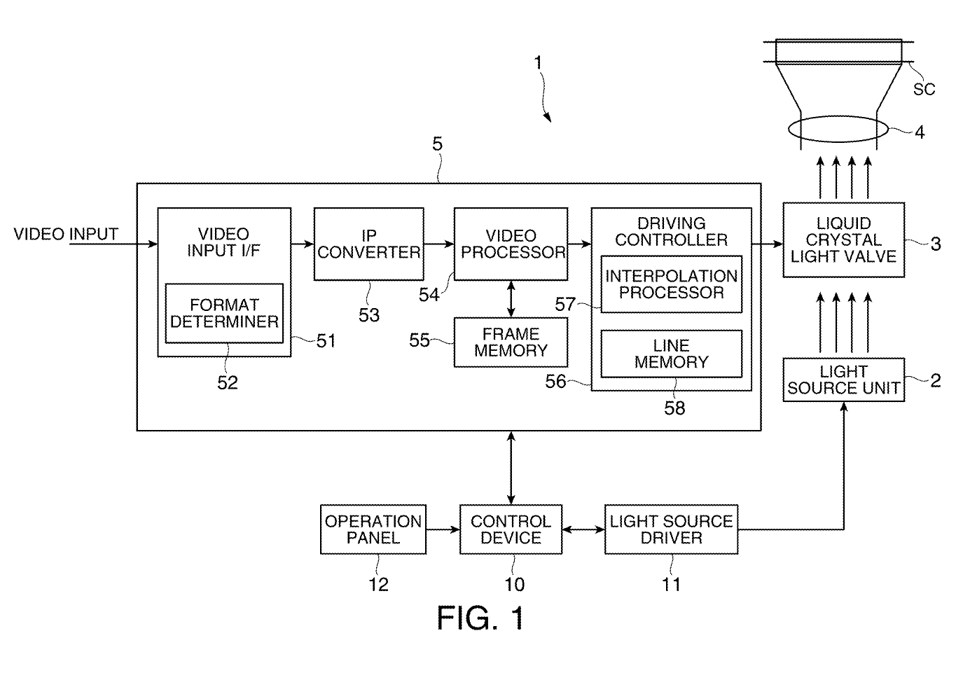

FIG. 1 is a diagram showing a functional configuration of a display device 1 according to an embodiment of the invention.

The display device 1 shown in FIG. 1 is a projector that projects a 3D (stereoscopic) image onto a screen SC, and includes a light source unit 2, a liquid crystal light valve 3 used as a modulator that modulates light emitted by the light source unit 2, and a projection optical system 4 that collects and diffuses the light modulated by the liquid crystal light valve 3 and projects the light onto the screen SC. A stereoscopic video picture that the display device 1 projects onto the screen SC is made up of a right-eye frame and a left-eye frame. The display device 1 projects the stereoscopic video picture onto the screen SC by a time-division method which alternately projects the right-eye frame and the left-eye frame onto the screen SC. A person who views this projection image wears a glasses-type filter which has a liquid crystal shutter, for example. To the person wearing the filter, only the right-eye image is visible to the right eye, and only the left-eye image is visible to the left eye. Thus, when the display device 1 projects the right-eye image and the left-eye image while switching them at a sufficiently high speed, the person wearing the filter can view a smooth image with the right and left eyes and thus can view a stereoscopic video picture. Moreover, the display device 1 may be configured to give reverse polarization or circular polarization to the right-eye image and the left-eye image using the projection optical system 4 and project the polarized images onto the screen SC. In this case, the person who views the projection image can view a stereoscopic video picture using a glasses-type filter which has a polarization lens or a circularly polarized lens.

The light source unit 2 includes a light source that includes a Xenon lamp, an ultrahigh-pressure mercury lamp, an LED, and the like. The light source unit 2 may include a reflecting mirror and an auxiliary reflecting mirror that guide light emitted by a light source to the liquid crystal light valve 3. Alternatively, the light source unit 2 may be one which includes a group of lenses (not shown) for enhancing the optical property of projected light, a polarizer, or a light control element or the like for decreasing the amount of light emitted by a light source on a path along which the light is guided to the liquid crystal light valve 3.

The liquid crystal light valve 3 includes three transmissive liquid crystal panels corresponding to the respective colors of RGB, and an image processed by a video processing device 5 is written on these transmissive liquid crystal panels. The liquid crystal light valve 3 is not limited to a configuration that includes three transmissive liquid crystal panels, but for example, may be configured in a type that one transmissive liquid crystal panel and a color filter are combined or a type including one or more reflective liquid crystal panels such as a LCOS (Liquid Crystal On Silicon) type.

The projection optical system 4 includes a prism that combines modulated light components of the three colors of RGB, modulated by the liquid crystal light valve 3 and a group of lenses that causes the projection image combined by the prism to be formed on the screen SC. When the liquid crystal light valve 3 is configured with one transmissive liquid crystal panel, a constituent element corresponding to the prism is not necessary.

Although the respective constituent elements relating to displaying of images, which include the light source unit 2, liquid crystal light valve 3, and projection optical system 4 correspond to a display unit according to the invention in their entirety, in particular, the liquid crystal light valve 3 corresponds to the display unit.

The display device 1 receives video sources (not shown) stored in its internal memory or stereoscopic video picture signals from an external image supply device (not shown) such as a personal computer or various video players.

The display device 1 includes a control device 10 that controls the overall operation of the display device 1, the video processing device 5 that alternately writes right-eye image data and left-eye image data to the liquid crystal light valve 3 based on the video sources or the image signals input from the external image supply device in accordance with the control of the control device 10, and a light source driver 11 that supplies a driving current to the light source unit 2 in accordance with the control of the control device 10 to turn the light source unit 2 on and off. The control device 10 is connected to an operation panel 12 which is disposed on the top or back surface of the body of the display device 1. The operation panel 12 includes a plurality of operation buttons or the like and generates and outputs an operation signal corresponding to an operation of these operation buttons to the control device 10.

In the video processing device 5 of the present embodiment, digital stereoscopic video picture data is input from the video source or the external image supply device. Exemplary formats of the data include side-by-side (half), top-and-bottom, line-by-line, and frame packing compatible to the HDMI standard, and exemplary resolutions thereof include 720 p, 1080 i, and 1080 p. The display device 1 is also capable of processing and displaying video data of the other formats, and in the present embodiment, the above video formats are suggested just as an example. In the present embodiment, the display device 1 will be described for a case of processing side-by-side video data.

The video processing device 5 includes a video input interface (I/F) 51 to which the video data is input, and the video input interface 51 includes a format determiner (determiner) 52 that determines the format of the video data. Moreover, the video processing device 5 includes an IP converter 53 that converts and outputs the video data input to the video input interface 51 into progressive (sequential scanning)-format data when the video data is interlaced (interlace scanning)—format data. The IP converter 53 outputs the video data input to the video input interface 51 without conversion when the video data is progressive-format data.

The video process device 5 includes a video processor 54 connected to a frame memory 55. The video processor 54 executes various kinds of processes such as frame rate (frame frequency) conversion, an OSD (On Screen Display) process, or a keystone correction (trapezoidal distortion correction) process on the video data output from the IP converter 53 in accordance with the control of the control device 10. The video processor 54 executes a process designated by the control of the control device 10 among the OSD process, the keystone correction process, and the frame rate conversion process. Thus, the video processor 54 may perform only some of these processes and may output the video data output from the IP converter 53 as it is without performing these processes.

The OSD process is a process of superimposing a menu image or a setting image for configuring the settings or the like of the display device 1 on the input video picture. The video processor 54 expands the video data output by the IP converter 53 into the frame memory 55 in units of frames and superimposes characters and graphics for displaying the OSD on the expanded frames to thereby generate new frame images. The keystone correction process is a process of modifying a video picture to be written to the liquid crystal light valve 3 when distortion occurs in the shape of a video picture formed on the screen SC due to a relative positional error between the screen SC and the optical axis of the display device 1 to thereby form a video picture having a proper (rectangular) shape on the screen SC. The video processor 54 modifies the frame images expanded into the frame memory 55 to thereby generate new frame images.

The frame rate conversion process is a process of converting the frame rate of the input video picture to a higher or lower frame rate. Moreover, when the input video picture includes a right-eye image and a left-eye image in one frame in accordance with the side-by-side format or the top-and-bottom format, the video processor 54 performs a process of separating these images to form individual frames through the frame rate conversion process.

For example, when side-by-side input video pictures are input, one frame of the video picture output by the IP converter 53 is made up of a right half frame of a right-eye image and a left half frame for a left-eye image. In this case, the video processor 54 performs a process of expanding one frame of the video picture output by the IP converter 53 into the frame memory 55 to divide the frame into two left and right-half frames and extracting and outputting the two frames (respectively of the right and left-eye images) as individual frames. In this way, one frame becomes two successive frames, and a frame (right-eye frame) of the right-eye image and a frame (left-eye frame) of the left-eye image are individually generated. Since this process involves increasing the frame count so as to be doubled, and as a result, the frame rate so as to be doubled, this process is referred to as a frame rate conversion process.

During these processes, the video processor 54 does not perform a resolution conversion process. That is, the resolution is not changed before and after the video processor 54 executes the respective processes of the OSD process, the keystone correction process, and the frame rate conversion process. For example, in the frame rate conversion process described above, although one frame of the side-by-side input video pictures is divided to obtain two individual frames, the vertical line count and the horizontal resolution of the respective frames are not changed from those when the frames are extracted from the original single frame.

The video processing device 5 includes a driving controller (display controller) 56 that drives the liquid crystal light valve 3 based on the video data output by the video processor 54. The driving controller 56 outputs the respective frames of the video data input from the video processor 54 to a liquid crystal display panel of the liquid crystal light valve 3 in units of lines to thereby write the video data to the liquid crystal display panel.

The driving controller 56 includes an interpolation processor 57 that performs a process of interpolating the pixel data and a line memory 58 that temporarily stores image data of one or plural lines when the interpolation processor 57 performs the interpolation process. The driving controller 56 outputs the data of each line to the liquid crystal light valve 3 in synchronization with the process of interpolating the pixel data by the interpolation processor 57. With this function, the driving controller 56 can increase the resolution of the respective frames. That is, when the display resolution of the liquid crystal light valve 3 is higher than that of the video data output by the video processor 54, the driving controller 56 increases the pixel count of the video data output from the video processor 54, and the interpolation processor 57 interpolates the data of deficient pixels. This process is performed for each line on which the driving controller 56 writes video data to the liquid crystal light valve 3. Thus, it is possible to obtain an advantage in that it is not necessary to write all of the data of one frame to the frame memory during the interpolation process, and the processing can be accelerated.

Next, the operation of the video processing device 5 will be described in more detail.

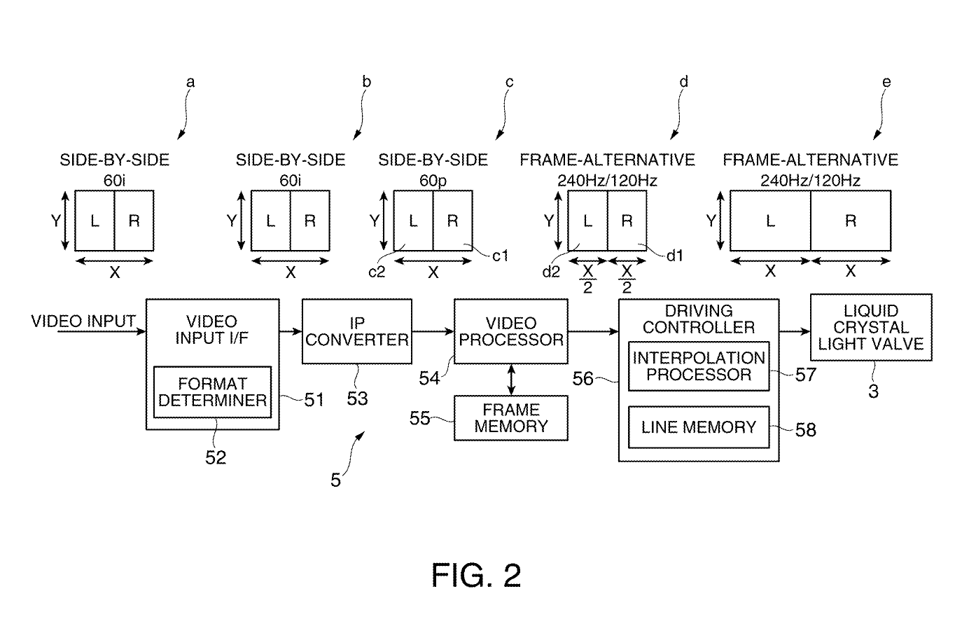

FIG. 2 is a diagram schematically showing the process performed by the video processing device 5. In FIG. 2, “a” indicates the input data input to the video processing device 5, “b” indicates the output data of the video input interface 51, “c” indicates the output data of the IP converter 53, “d” indicates the output data of the video processor 54, and “e” indicates the writing data written by the driving controller 56. In the example of FIG. 2, it is assumed that the video processor 54 does not perform the OSD process and the keystone correction process.

FIG. 2 shows a case where the frame rate of the input data “a” is 60 i (interlaced format of 60 fields per second) as an example. The resolution of the input data “a” is represented by a horizontal resolution X and the vertical line count Y of a pixel. For example, when the resolution of the input data “a” is 1080 i, X=1920 and Y=1080. The input data “a” is side-by-side stereoscopic video picture data. The side-by-side stereoscopic video picture data has respective frames in which a right-eye image (R) and a left-eye image (L) are combined in the horizontal direction. Thus, the half in the horizontal direction of each frame of the input data “a” is made up of the right-eye image (R), and the other half is made up of the left-eye image (L), the horizontal resolution of the respective right and left-eye images is X/2.

The video input interface 51 determines the video format of the input data “a” by the function of the format determiner 52 to thereby specify the frame rate 60 i, the horizontal resolution X, the vertical line count Y, and that the input data “a” is side-by-side stereoscopic video picture data. Since the input data “a” is digital video data, information indicating the video format of the input data “a” is attached to the frame data as additional information and input to the video input interface 51. Thus, the format determiner 52 can easily determine the video format by referencing the additional information of the input data “a”. The video input interface 51 outputs control information indicating the video format of the input data “a” to the IP converter 53 and the output data “b” to the IP converter 53. Although the output data “b” is substantially the same as the input data “a,” the configuration and the presence of the additional information are changed.

When the video format of the input data determined by the format determiner 52 is the interlaced format, the IP converter 53 combines the respective fields of the input data “a” to generate progressive-format frames to generate and output the output data “c” to the video processor 54. In the example of FIG. 2, the output data “b” having the frame rate of 60 i is converted into the output data “c” having the frame rate of 60 p and is output.

The video processor 54 expands the output data “c” of the IP converter 53 into the frame memory 55, converts the data into frame-alternative video data, and outputs the data as the output data “d”. That is, the video processor 54 expands the output data “c” into the frame memory 55 to divide one frame into two left and right frames and uses the right half “c1” as one frame “d1” and the left half “c2” as another frame “d2”. Since the frame count is doubled by this process, the frame rate of the output data “d” of the video processor 54 becomes 120 Hz which is twice the frame rate 60 p of the output data “c”. The respective frames of the output data “d” have such a size that the horizontal resolution is X/2 and the vertical line count is Y. That is, the video processor 54 does not change the resolution after creating one frame using the half of the output data “c” having the horizontal resolution X and the vertical line count Y. Thus, the size of the respective frames d1 and d2 of the output data “d” is X/2 which is the same as the size of the half frames c1 and c2 of the output data “c”.

When writing the output data “d” of the video processor 54 to the liquid crystal display panel of the liquid crystal light valve 3, as described above, the driving controller 56 increases the resolution by causing the interpolation processor 57 to interpolate the pixel data. When writing the frame “d1” of the output data “d,” the driving controller 56 acquires one line of the frame “d1” and doubles the horizontal resolution of one line of data. As a result, the driving controller 56 writes the writing data “e” of which the horizontal resolution is expanded twice to the liquid crystal light valve 3. In this way, a frame in which the right-eye image compressed in the horizontal direction in the state of the input data “a” is expanded in the horizontal direction and a frame in which the left-eye image compressed in the horizontal direction is similarly expanded in the horizontal direction are alternately written to the liquid crystal light valve 3.

As above, the video processor 54 divides one frame of the input data “a” into the left and right frames to generate a right-eye frame and a left-eye frame and outputs the output data “d” which is the stereoscopic video picture including these frames. The driving controller 56 interpolates the pixels in the horizontal direction for each horizontal line with respect to the right-eye frame dl and the left-eye frame d2 of the output data “d” of the video processor 54 to thereby increase the horizontal resolution. Thus, it is possible to generate the right-eye frame and the left-eye frame at high speed from the side-by-side stereoscopic video pictures and to convert the resolution of the generated frames at high speed by performing horizontal interpolation. Moreover, it is possible to sequentially display the converted video pictures in units of horizontal lines. In this way, it is possible to convert the frame rate and the resolution of the stereoscopic video pictures at high speed and to display the stereoscopic video pictures smoothly with few resources.

In the stereoscopic video data of the side-by-side format as the first video format, illustrated in FIG. 2, since the right-eye image and the left-eye image are arranged in the horizontal direction and combined to form one frame or one field, the original right-eye image and left-eye image are compressed so that the horizontal resolution thereof is halved. When each the right-eye image and the left-eye image is used as an independent single frame, it is necessary to expand the horizontal resolution.

As for the side-by-side format, two compression methods to be used when generating one frame or one field by combining the right-eye image and the left-eye image are known. One is a horizontal thinning method of thinning pixels at specific positions in the horizontal direction, and the other is a zigzag thinning method of shifting the positions of thinning pixels between upper and lower lines. When the input data “a” is the side-by-side stereoscopic video data, the format determiner 52 determines whether the compression method uses a horizontal thinning method or a zigzag thinning method. The driving controller 56 interpolates the pixel data depending on the method determined by the format determiner 52.

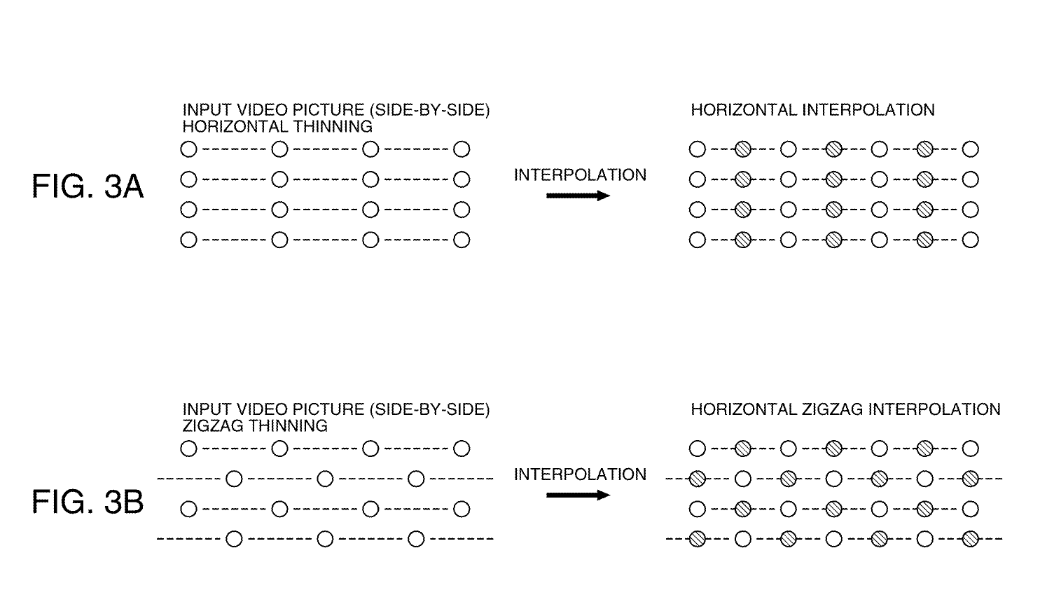

FIGS. 3A and 3B are diagrams schematically showing a process of the driving controller 56 interpolating pixel data of respective frames, in which FIG. 3A shows a process of performing horizontal interpolation on the pixel data, and FIG. 3B shows a process of performing horizontal zigzag interpolation on the pixel data. The state before the interpolation process is shown on the left side of FIGS. 3A and 3B, and the state after the interpolation process is shown on the right side. In the figures, an empty circle represents one pixel, and a hatched circle represents a pixel added by interpolation.

As shown in FIG. 3A, pixels at regular positions in the horizontal direction are omitted in the frame of the output data “d” which has been subjected to horizontal thinning. The positions where pixels are omitted are the same in the respective lines, and the omitted pixels are arranged in a line in the vertical direction. When expanding the output data “d” in the horizontal direction, the interpolation processor 57 generates new pixel data based on the data of pixels before and after (on the left and right side in the figure) of pixels that are to be interpolated to thereby fill the deficient pixels as shown on the right side of FIG. 3A. In this case, it is possible to obtain an advantage in that the amount of data calculated by the interpolation process is small, and the interpolation process can be accelerated. Moreover, it is only necessary to store a very small amount of data in the line memory 58 for the interpolation process. When the driving controller 56 or the interpolation processor 57 can maintain data of one pixel, it may be possible to perform the interpolation process without using the line memory 58.

On the other hand, as shown in FIG. 3B, the pixels omitted from the output data “d” are arranged in a zigzag pattern. In this case, since the positions of the omitted pixels are different in the respective lines, the omitted pixels are not arranged in the vertical or horizontal direction. When interpolating the output data “d,” the interpolation processor 57 generates new pixel data based on pixels before and after (on the left and right sides in the figure) of pixels that are to be interpolated and pixels above and below the pixels interpolated. That is, the interpolation processor 57 generates new pixel data based on data of the four pixels before and after and above and below a pixel to be interpolated in a state where data of a target line subjected to the interpolation process and data of the lines above and below the target line are stored in the line memory 58 to thereby fill the deficient pixels. In this case, it is possible to obtain an advantage in that since interpolation is performed based on the data of a larger number of pixels, the interpolated pixel is more unlikely to generate a sense of discomfort. By doing so, it is possible to increase the resolution of an image without creating unnatural artifacts. When realizing a high resolution by interpolating the input data “a” which has been subjected to zigzag thinning, since the driving controller 56 can perform the interpolation process by storing image data of just several lines in the line memory 58, it is possible to suppress the amount of processing data and to accelerate the processing.

As above, the driving controller 56 converts the resolution into a high resolution by interpolating the data of the respective frames of the stereoscopic video pictures compressed in the horizontal direction depending on the compression state (for example, horizontal thinning and zigzag thinning) so that video pictures before compression can be reproduced. Thus, it is possible to display high-quality stereoscopic video pictures. Moreover, as for video data employing other compression methods, the interpolation processor 57 converts the resolution by performing different processing depending on the compression method, whereby high-quality stereoscopic video pictures with no sense of discomfort can be displayed.

In the example shown in FIG. 2 and FIGS. 3A and 3B, although an example in which the driving controller 56 expands the output data “d” of the video processor 54 so that the horizontal resolution is doubled has been described, the invention is not limited to this. The driving controller 56 performs a process of converting the resolution of the output data “d” so as to match the display resolution of the liquid crystal display panel of the liquid crystal light valve 3 by the function of the interpolation processor 57. Thus, the driving controller 56 may execute a process wherein the expansion ratio is not 2 depending on the resolution of the output data “d” and the display resolution of the liquid crystal light valve 3.

Moreover, as shown in FIG. 2, the video processor 54 is capable of as well as outputting the output data “d” at the frame rate of 120 Hz (120 frames per second), outputting the output data “d” at the frame rate of 240 Hz. In this case, the video processor 54 generates frame-alternative data from the output data “c” of the IP converter 53 and further generates the output data “d” so that the respective frames are repeatedly written twice. A case of doubling the frame rate will be described.

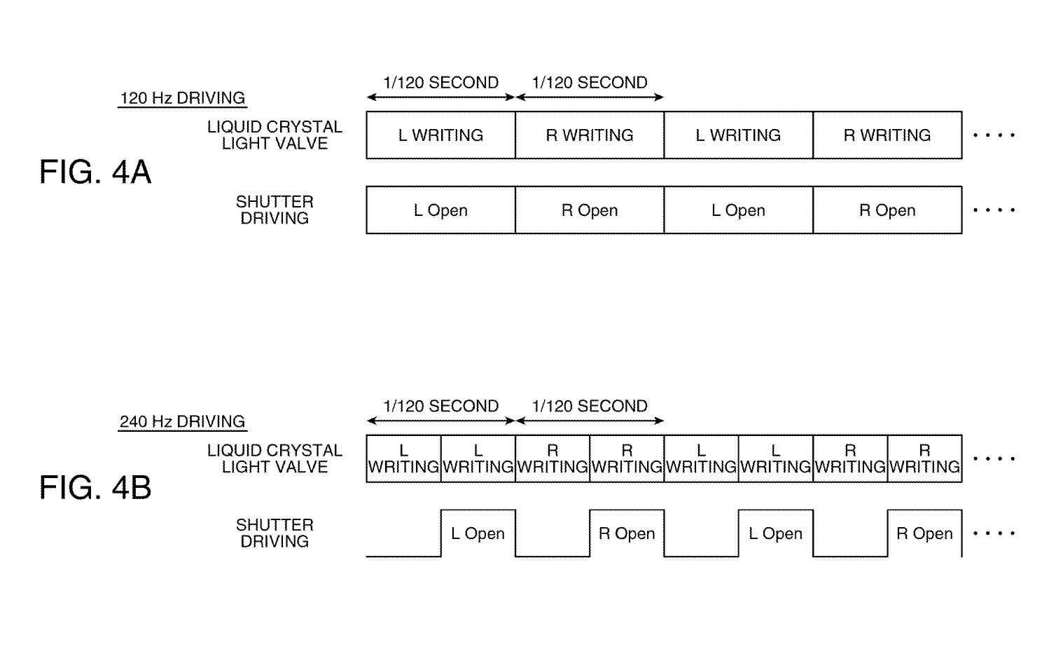

FIGS. 4A and 4B are diagrams showing the relationship between the timings of the writing of a liquid crystal light valve and the opening/closing of a filter, in which FIG. 4A shows the timings when driving at 120 Hz, and FIG. 4B shows the timings when driving at 240 Hz. FIGS. 4A and 4B show an operation when a person who views stereoscopic video pictures projected onto the screen SC (FIG. 1) wears a glasses-type filter having a liquid crystal shutter.

As shown in FIG. 4A, when driving the liquid crystal light valve 3 at 120 Hz to display stereoscopic video pictures, the driving controller 56 writes the right-eye image having 60 frames per second and the left-eye image having 60 frames per second to the liquid crystal light valve 3. Thus, both the time (denoted by “L writing” in the figure) needed for writing one left-eye frame and the time (denoted by “R writing” in the figure) needed for writing one right-eye frame are 1/120 second. In this case, the shutter of the glasses-type filter operates such that the left-eye shutter is opened when the left-eye image is written and the right-eye shutter is opened when the right-eye image is written.

In contrast, when driving the liquid crystal light valve 3 at 240 Hz that is twice 120 Hz, as shown in FIG. 4B, the right-eye image and the left-eye image each are repeatedly written twice. That is, the driving controller 56 writes one image to the liquid crystal light valve 3 twice in a shorter period and at higher speed. One writing (“L writing” and “R writing” in the figure) is performed in 1/240 second, and the switching cycle of the left and right images is 1/120 second.

In this case, the shutter of the glasses-type filter operates in the following manner. The left-eye shutter is opened when the first writing of the left-eye image ends and is closed when the writing of the right-eye image starts. The right-eye shutter is opened when the first writing of the right-eye image ends and is closed when the writing of the left-eye image starts.

Since the driving controller 56 performing writing by scanning the liquid crystal display panel in the vertical direction, a residual image of a previous screen may appear in a part of the screen until writing of the entire one screen ends. As shown in FIG. 4B, if the shutter is opened after writing ends and is closed before writing of the next image starts, the previous and next images will barely be visible. Thus, it is possible to display clearer stereoscopic video pictures.

As shown in FIG. 4B, when driving the liquid crystal light valve 3 at 240 Hz, it is only necessary to write one frame twice. Thus, although the video processor 54 may generate video data having a frame rate of 240 frames per second, the invention is not limited to this configuration. For example, the video processor 54 may generate video data having a frame rate of 120 frames per second, and the driving controller 56 may write one frame twice based on the video data having the frame rate of 120 frames per second. In this case, the driving controller 56 may drive the liquid crystal light valve 3 at cycles half the vertical synchronization signal of the output data “d” of the video processor 54 and write one frame twice. In this case, it is possible to obtain an advantage in that the stereoscopic video pictures can be displayed in a clearer manner without increasing the processing load of the video processor 54.

Moreover, the display device 1 may process stereoscopic video pictures of other video formats without limiting to the input data of the side-by-side format.

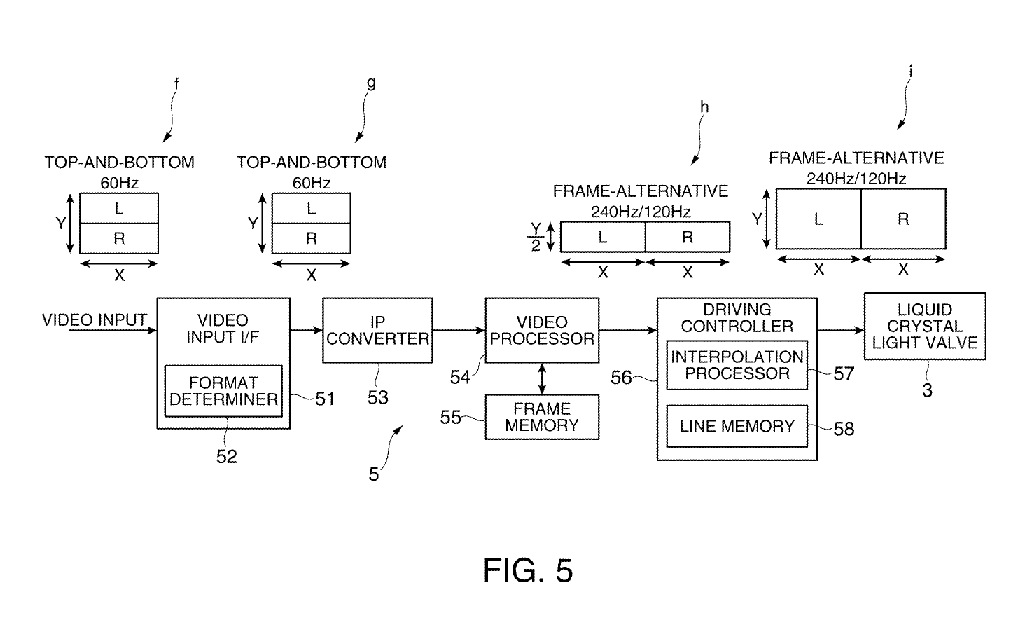

FIG. 5 is a diagram schematically showing the operation of the video processing device 5 when the display device 1 processes top-and-bottom input data including frames in which the right-eye image and the left-eye image are combined in the vertical direction. In FIG. 5, “f” indicates the input data input to the video processing device 5, “g” indicates the output data of the video input interface 51, “h” indicates the output data of the video processor 54, and “i” indicates the writing data written by the driving controller 56. In the example of FIG. 5, it is assumed that the video processor 54 does not perform the OSD process and the keystone correction process.

In the example shown in FIG. 5, the input data “f” is stereoscopic video data of the top-and-bottom format (second video format) having the frame rate of 60 Hz. The horizontal resolution of the input data “f” is X, and the pixel vertical line count is Y. For example, if the resolution of the input data “f” is 720 p, X=1280 and Y=720. The respective frames of the input data “f” are configured such that the right-eye image and the left-eye image are arranged in the vertical direction, and the upper half of the frame is made up of the left-eye image and the lower half of the frame is made up of the right-eye image. The right-eye image and the left-eye image are combined to form one frame by being compressed so that the vertical line count is halved (Y/2).

The video input interface 51 determines the video format of the input data “f” by the function of the format determiner 52 to thereby specify the frame rate 60 Hz, the horizontal resolution X, the vertical line count Y, and that the input data “f” is top-and-bottom stereoscopic video picture data. The video input interface 51 outputs control information indicating the video format of the input data “f” to the IP converter 53 and the output data “g” to the IP converter 53. Although the output data “g” is substantially the same as the input data “f,” the configuration and the presence of the additional information are changed.

When the video format of the input data determined by the format determiner 52 is the interlaced format, the IP converter 53 combines the respective fields of the input data “f” to generate and output progressive-format frames to the video processor 54. In the example of FIG. 5, since the output data “g” has the progressive format, the IP converter 53 outputs the output data “g” to the video processor 54 as it is.

The video processor 54 expands the output data of the IP converter 53 into the frame memory 55, converts the data into frame-alternative video data, and outputs the data as the output data “h”. Specifically, the video processor 54 expands the output data “g” into the frame memory 55 to divide one frame into two left and right frames and uses each of the upper and lower halves of one frame as a single frame. Since the frame count is doubled by this process, the frame rate of the output data “h” of the video processor 54 becomes 120 Hz which is twice the frame rate 60 p of the output data “g”. Here, as described above, the video processor 54 may generate the output data “h” having the frame rate of 240 Hz. The respective frames of the output data “h” have such a size that the horizontal resolution is X and the vertical line count is Y/2. This is because the video processor 54 does not change the resolution after creating one frame using the half of the output data “g” having the horizontal resolution X and the vertical line count Y.

When writing the output data “h” of the video processor 54 to the liquid crystal display panel of the liquid crystal light valve 3, the driving controller 56 increases the resolution by causing the interpolation processor 57 to interpolate the pixel data. As a result, the driving controller 56 writes the expanded writing data “i” to the liquid crystal light valve 3. That is, a frame in which the right-eye image compressed in the vertical direction in the state of the input data “f” is expanded and a frame in which the left-eye image compressed in the vertical direction is similarly expanded are alternately written to the liquid crystal light valve 3.

As above, the video processor 54 divides one frame of the top-and-bottom stereoscopic video pictures into the upper and lower frames to generate a right-eye frame and a left-eye frame. The driving controller 56 interpolates the horizontal lines with respect to the right-eye frame and the left-eye frame to thereby increase the vertical resolution, and then displays the frames to the liquid crystal light valve 3. Thus, it is possible to generate the right-eye frame and the left-eye frame at high speed from the top-and-bottom stereoscopic video pictures and to convert the resolution of the frames by performing vertical interpolation. Moreover, it is possible to sequentially display the converted video pictures. In this way, it is possible to convert the frame rate and the resolution of the stereoscopic video pictures at high speed and to display the stereoscopic video pictures smoothly with few resources.

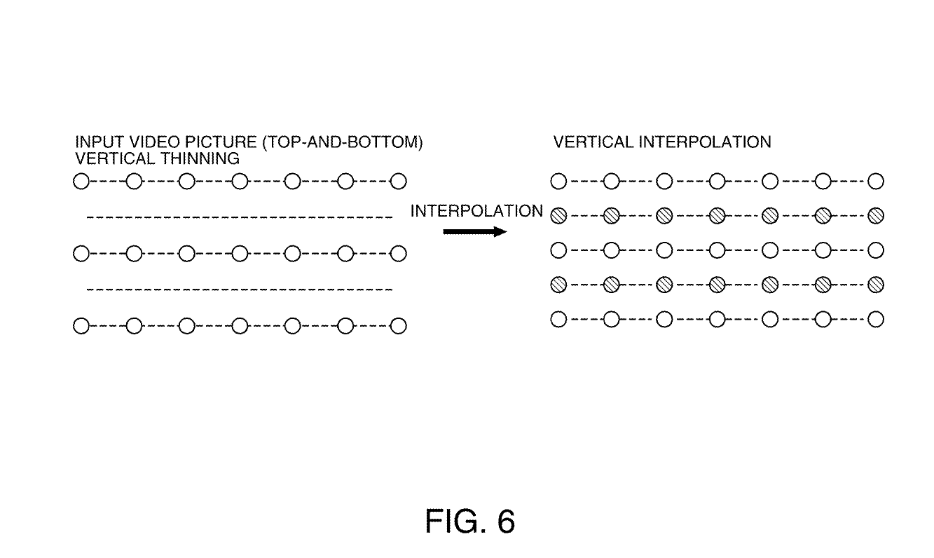

FIG. 6 is a diagram schematically showing a process of interpolating pixel data of respective frames in the vertical direction. The state before the interpolation process is shown on the left side of FIG. 6, and the state after the interpolation process is shown on the right side. In the figures, an empty circle represents one pixel, and a hatched circle represents a pixel added by interpolation.

As shown in FIG. 6, the top-and-bottom stereoscopic video data is one in which each of the right-eye image and the left-eye image is compressed by skipping the vertical lines at intervals of one or several lines. Thus, the driving controller 56 performs a process of interpolating lines by the function of the interpolation processor 57. In this process, one or plural lines of data of the output data “h” of the video processor 54 are stored in the line memory 58, and the pixel data of an interpolation target line is generated based on the pixel data of the lines above and below the interpolation target line. Moreover, the driving controller 56 sequentially writes the data of the line stored in the line memory 58 and the data of the interpolated line to the liquid crystal light valve 3. In this case, similarly to the case shown in FIG. 2, it is possible to obtain an advantage in that the amount of data calculated by the interpolation process is small, and the interpolation process can be accelerated.

As above, the driving controller 56 converts the resolution into a high resolution by interpolating the data of the respective frames of the stereoscopic video pictures compressed in the horizontal direction depending on the compression state so that video pictures before compression can be reproduced.

As the format of the stereoscopic video data similar to the top-and-bottom format, a line-by-line format used as the third video format is known. In this format, right and left-eye images with parallax are compressed in the vertical direction similarly to the top-and-bottom format to thereby form one frame. In the top-and-bottom format, the upper and lower halves of the frame are made up of the right-eye image and the left-eye image, respectively. In contrast, in the line-by-line format, the right-eye image and the left-eye image are alternately mixed in units of lines, and the right-eye image and the left-eye image are combined in units of horizontal lines to form one frame.

When processing the line-by-line stereoscopic video data, in the process wherein the video processor 54 separates the right-eye image and the left-eye image to form individual single frames, by alternately extracting lines so as to match the line-by-line format and performing the other processes similarly to the top-and-bottom format, it is possible to display stereoscopic video pictures.

That is, the video processor 54 distributes one frame of the line-by-line stereoscopic video data into the right-eye image and the left-eye image in units of horizontal lines to form a right-eye frame and a left-eye frame and outputs stereoscopic video data including these frames. The driving controller 56 interpolates the horizontal lines similarly to the top-and-bottom video data with respect to the right-eye frame and the left-eye frame of the stereoscopic video data output by the video processor 54 to increase the vertical resolution, and then displays the frames to the liquid crystal light valve 3. By doing so, it is possible to generate the right-eye frame and the left-eye frame at high speed from the line-by-line stereoscopic video pictures and to convert the resolution of the frames by performing vertical interpolation. Moreover, it is possible to sequentially display the converted video pictures. In this way, it is possible to convert the frame rate and the resolution of the stereoscopic video pictures at high speed and to display the stereoscopic video pictures smoothly with few resources.

As described above, according to the embodiment of the invention, the display device 1 includes the video processing device 5 including: the format determiner 52 that determines the video format of the input video pictures including the right-eye image and the left-eye image; the video processor 54 that expands the input video pictures into the frame memory 55 so as to match the video format determined by the format determiner 52 to generate the right-eye frame and the left-eye frame and outputs stereoscopic video data including these frames while substantially converting the frame rate; the liquid crystal light valve 3 that displays images with a predetermined display resolution; and the driving controller 56 that displays the respective frames constituting the stereoscopic video pictures output by the video processor 54 to the liquid crystal light valve 3 while converting the resolution so as to match the display resolution of the liquid crystal light valve 3. In the display device 1, the resolution is not converted when the video processor 54 performs the process of generating the right-eye frame and the left-eye frame from the stereoscopic video pictures including the right-eye image and the left-eye image, but the resolution is converted so as to match the display resolution of the liquid crystal light valve 3 when the driving controller 56 writes data to the liquid crystal light valve 3.

According to this configuration, since the display device 1 does not have a step which involves storing resolution-converted video pictures in the frame memory and processing the video pictures, it is possible to save the resources for processing the video pictures of which the amount of information is increased due to resolution conversion. Thus, it is possible to decrease the processing load when displaying an input video picture having a resolution different from a display resolution and to display a high-resolution image smoothly at a high frame rate. Moreover, it is possible to realize a display device capable of displaying stereoscopic video pictures smoothly with an inexpensive configuration without using hardware having high processing performance and a large-capacity memory. Here, since the video processor 54 does not perform resolution conversion when generating the right-eye frame and the left-eye frame, a memory for expanding video pictures having a high resolution through resolution conversion is not needed. Thus, it is possible to decrease the load associated with a series of processes of converting the resolution of video pictures and displaying the resolution-converted video pictures.

In addition, since the driving controller 56 processes respectively in units of horizontal lines the right-eye frame and the left-eye frame generated by the video processor 54 and displays the frames to the liquid crystal light valve 3, a step of expanding the video pictures of which the resolution is converted by the driving controller 56 into the frame memory is not needed. Thus, it is possible to display high-resolution video pictures smoothly at a high frame rate.

Moreover, when stereoscopic video pictures having any one of the top-and-bottom and line-by-line video formats are input as input data, the display device 1 displays the stereoscopic video pictures. That is, the display device 1 can convert stereoscopic video pictures having such a format that right and left-eye images with parallax are compressed in the horizontal or vertical direction into video pictures including the right and left-eye images as individual frames while suppressing the processing load and expand the compressed frames using the driving controller 56 when displaying the frames. In this way, it is possible to expand and display the stereoscopic video pictures having the compressed video format at high speed.

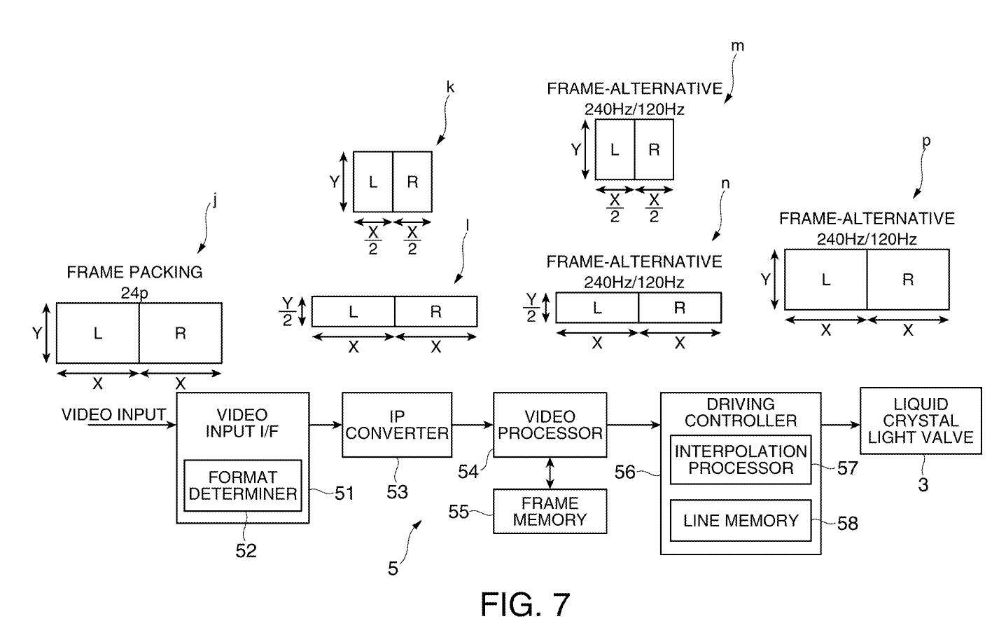

FIG. 7 is a diagram schematically showing the operation of the video processing device 5 when processing input data of the frame packing format as the fourth video format.

In the frame packing stereoscopic video data, the right-eye image and the left-eye image each have the same size as one frame, and the right-eye image and the left-eye image are combined to form one frame. Thus, the input data itself has a high resolution as compared to the side-by-side or top-and-bottom format. For example, a right-eye image and a left-eye image having the normal resolution of 1920 by 1080 dots may be combined in the horizontal direction to form one horizontally long frame of 1920 by 2160 dots. When displaying frame packing input data, the display device 1 may write data to the liquid crystal light valve 3 without changing the resolution and may decrease the resolution of the video data processed by the video processor 54 to thereby realize a reduction in the processing load. This case will be described with reference to FIG. 7. In FIG. 7, “j” indicates the input data input to the video processing device 5, “k” and “l” indicate the output data of the IP converter 53, “m” and “n” indicate the output data of the video processor 54, and “p” indicates the writing data written by the driving controller 56. In the example of FIG. 7, it is assumed that the video processor 54 does not perform the OSD process and the keystone correction process.

In the example shown in FIG. 7, the input data “j” is stereoscopic video data including 24 frames per second and is made up of right and left-eye images having the normal size, namely a non-compressed size. The horizontal resolution of the input data “j” is X, and the pixel vertical line count is Y. For example, if the resolution of the input data “j” is 720 p, X=1280 and Y=720. If the resolution is 1080 p, X=1920 and Y=1080.

The video input interface 51 determines the video format of the input data “j” by the function of the format determiner 52 to thereby specify the frame rate 24 Hz, the horizontal resolution X, the vertical line count Y, and that the input data “j” is frame packing stereoscopic video picture data. The video input interface 51 outputs control information indicating the video format of the input data “j” to the IP converter 53 and the output data to the IP converter 53.

When the video format of the input data “j” determined by the format determiner 52 is the interlaced format, the IP converter 53 combines the respective fields of the input data “j” to generate and output progressive-format frames to the video processor 54. Moreover, the IP converter 53 performs a process of compressing the input data “j” having the frame packing format in the horizontal or vertical direction. For example, the IP converter 53 generates the output data “k” obtained by compressing the horizontal resolution of the frame packing input data j by 50% or the output data “l” obtained by compressing the vertical line count of the input data “j” by 50% and outputs the output data “k” or “l” to the video processor 54.

The video processor 54 expands the output data “k” or the output data “l” of the IP converter 53 into the frame memory 55 and converts the frame rate to output frame-alternative video data having the frame rate of 120 Hz or 240 Hz. When the output data “k” is input from the IP converter 53, the video processor 54 outputs the output data “m” of which the horizontal resolution is compressed by 50% to the driving controller 56. Moreover, when the output data “l” is input from the IP converter 53, the video processor 54 outputs the output data “n” of which the vertical line count is compressed by 50% to the driving controller 56.

When writing the output data “m” or the output data “n” of the video processor 54 to the liquid crystal display panel of the liquid crystal light valve 3, the driving controller 56 increases the resolution so as to match the display resolution of the liquid crystal light valve 3 by causing the interpolation processor 57 to interpolate the pixel data and writes data to the liquid crystal light valve 3. As a result, the driving controller 56 writes the writing data “p” obtained by expanding the horizontal resolution of the output data “m” to the same resolution as the input data “j” or the writing data “p” obtained by expanding the vertical line count of the output data “n” to the same resolution as the input data “j” to the liquid crystal light valve 3. That is, the frames compressed by the IP converter 53 are restored to their original size by the interpolation processor 57 performing interpolation so as to compensate for the compression, and the restored frames are written.

As above, the IP converter 53 compresses the vertical or horizontal resolution of the frame packing input video pictures and then outputs the compressed video data. The video processor 54 divides one frame of the compressed video data into left and right half frames to generate the right-eye frame and the left-eye frame and outputs the stereoscopic video pictures including these frames. The driving controller 56 increases the resolution so as to compensate for the compression by interpolating the pixels in the horizontal direction in unit of horizontal lines or interpolating the horizontal lines and then displays the data to the liquid crystal light valve 3.

In this case, since the data subjected to the process wherein the video processor 54 converts the frame rate is the data of which the horizontal resolution or the vertical line count is compressed, it is possible to decrease the amount of data expanded into the frame memory 55. In this way, it is possible to realize a reduction in the processing load of the video processor 54, process high-resolution stereoscopic video pictures with few resources, and display the stereoscopic video pictures smoothly.

The embodiment described above is just an example of a specific application form of the invention and is not intended to restrict the invention. The invention may be applied in other forms different from the embodiment described above. For example, in the display device 1 of the embodiment, when the video processor 54 executes the keystone correction process or the OSD process, the shape to be corrected by the keystone correction and the character size of the OSD display may be adjusted taking a change in the resolution due to the interpolation process by the driving controller 56 into consideration. Moreover, for example, the display device according to the invention is not limited to the projector that projects 3D (stereoscopic) video pictures onto the screen SC as described above. Various display devices such as a self-emitting display device, for example, a liquid crystal monitor or a liquid crystal TV that displays 3D images/video pictures on a liquid crystal display panel, or a monitor device or a television receiver that displays 3D images/video pictures on a PDP (Plasma Display Panel), and a monitor device or a television receiver that displays 3D images/video pictures on an organic EL display panel called OLED (Organic Light-Emitting Diode) or OEL (Organic Electro-Luminescence) are also included in the image display device according to the invention. In this case, the liquid crystal display panel, the plasma display panel, and the organic EL display panel correspond to the image display unit. Moreover, the respective functional units of the display device 1 shown in FIGS. 1, 2, 5, and 7 illustrate the functional configuration of the display device, and specific mounting forms are not particularly limited. That is, it is not always necessary to individually mount corresponding hardware to the respective functional units, and one processor may realize the functions of a plurality of functional units by executing program.

What is claimed is:

1. A display device comprising:
a determiner that determines a video format of a stereoscopic video picture which is input as an input video picture and includes a right-eye image and a left-eye image;
a video processor that generates a right-eye frame and a left-eye frame from the input video picture based on the video format determined by the determiner and outputs a stereoscopic video picture including the right-eye frame and the left-eye frame;
a display unit that displays images with a predetermined display resolution; and
a display controller that converts the resolution of the respective frames included in the stereoscopic video picture output by the video processor into the display resolution and causes the display unit to display the images.

2. The display device according to claim 1,
wherein the video processor generates the right-eye frame and the left-eye frame without converting the resolution of the input video picture into a higher resolution and outputs the stereoscopic video picture including the right-eye frame and the left-eye frame.

3. The display device according to claim 1,
wherein the video processor generates the right-eye frame and the left-eye frame having a lower resolution than the display resolution and outputs the stereoscopic video picture including the right-eye frame and the left-eye frame.

4. The display device according to claim 1,
wherein the video processor generates the right-eye frame and the left-eye frame based on any one of the input video picture of which the resolution is not converted and the input video picture of which the resolution is converted into a lower resolution.

5. The display device according to claim 1,
wherein the display controller processes respectively in units of horizontal lines the right-eye frame and the left-eye frame output by the video processor and causes the display unit to display the images.

6. The display device according to claim 1,
wherein when the video format of the input video picture determined by the determiner is a first video format including a frame in which the right-eye image and the left-eye image which are compressed are combined in a horizontal direction,
the video processor divides one frame of the input video picture to generate a right-eye frame and a left-eye frame and outputs a stereoscopic video picture including the right-eye frame and the left-eye frame, and
the display controller interpolates pixels in the horizontal direction in units of horizontal lines of the right-eye frame and the left-eye frame included in the stereoscopic video picture output by the video processor to thereby increase a horizontal resolution.

7. The display device according to claim 1,
wherein when the video format of the input video picture determined by the determiner is a second video format including a frame in which the right-eye image and the left-eye image which are compressed are combined in a vertical direction,
the video processor divides one frame of the input video picture to generate a right-eye frame and a left-eye frame and outputs a stereoscopic video picture including the right-eye frame and the left-eye frame, and
the display controller interpolates horizontal lines of the right-eye frame and the left-eye frame included in the stereoscopic video picture output by the video processor to thereby increase a vertical resolution.

8. The display device according to claim 1,
wherein when the video format of the input video picture determined by the determiner is a third video format including a frame in which the right-eye image and the left-eye image which are compressed are combined in units of horizontal lines to form one frame,
the video processor distributes one frame of the input video picture into the right-eye image and the left-eye image in units of horizontal lines to generate a right-eye frame and a left-eye frame and outputs a stereoscopic video picture including the right-eye frame and the left-eye frame, and
the display controller interpolates horizontal lines of the right-eye frame and the left-eye frame included in the stereoscopic video picture output by the video processor to thereby increase a vertical resolution.

9. The display device according to claim 1, further comprising
a converter that decreases a vertical or horizontal resolution of the input video picture and outputs the video picture when the video format of the input video picture determined by the determiner is a fourth video format including a frame in which the right-eye image and the left-eye image are combined,
wherein the video processor divides one frame of the video picture output by the converter to generate a right-eye frame and a left-eye frame and outputs a stereoscopic video picture including the right-eye frame and the left-eye frame, and
wherein the display controller interpolates pixels in the horizontal direction in units of horizontal lines or interpolates the horizontal lines of the right-eye frame and the left-eye frame included in the stereoscopic video picture output by the video processor to thereby increase a resolution.

10. The display device according to claim 6,
wherein the display controller determines a compression state of the video picture output by the video processor and interpolates pixels or horizontal lines in accordance with a method corresponding to the determined compression state.

11. A display method comprising:
determining a video format of a stereoscopic video picture which is input as an input video picture and includes a right-eye image and a left-eye image;
generating a right-eye frame and a left-eye frame from the input video picture based on the determined video format and outputting a stereoscopic video picture including the right-eye frame and the left-eye frame; and
converting the resolution of the respective frames included in the output stereoscopic video picture into a predetermined display resolution and displaying images with the display resolution.
